(19) United States
(12) Patent Application Publication
(10) Pub. No.: US 2024/0059941 A1
(43) Pub. Date: Feb. 22, 2024

(54) Acrylic pressure sensitive adhesive composition for food packaging label application

(71) Applicant: UPM RAFLATAC OY, Tampere (FI)

(72) Inventor: Tibor PERNECKER, Helsinki (FI)

(21) Appl. No.: 18/266,648

(22) PCT Filed: Dec. 16, 2021
(86) PCT No.: PCT/FI2021/050883

§ 371 Date: Jun. 12, 2023

(30) Foreign Application Priority Data
Dec. 18, 2020 (FI) 20206341

(51) Int. Cl. C09J 133/08; C09J 7/38; B65D 23/14; G09F 3/02; G09F 3/10

(52) U.S. Cl. CPC C09J 133/08; C09J 7/385; B65D 23/14; G09F 3/02; G09F 3/10; G09F 2003/0225; G09F 2003/023; G09F 2003/0273

(57) ABSTRACT

The invention relates to a pressure sensitive adhesive (PSA) composition for clear-on-clear labels. The PSA composition contains an aqueous polymer emulsion comprising an acrylic-based copolymer derived from components including (i) monomers comprising acrylate monomer(s) and vinyl aromatic compound(s), (ii) a reactive surfactant and (iii) a chain transfer agent. The pressure sensitive adhesive composition is resistant to water whitening and is in compliance with demands on food contact materials. Further, the invention relates to use of said PSA composition as well as to an adhesive label (1) comprising the PSA composition, a labelled item (101) comprising said adhesive label and a label laminate web (8) for providing the adhesive labels.

### TECHNICAL FIELD

This specification relates to a pressure sensitive adhesive composition as well as to a label and a label laminate web comprising the pressure sensitive adhesive composition. Further, the application concerns a combination of a label and an item.

### BACKGROUND

Clear-on-clear labels may be used for providing a transparent package with ‘no label’ look. Clear-on-clear labels refer to labels that have a clear, i.e. transparent, film as their face. In order to provide a clear label, also the adhesive of the label must be transparent or clear. Clarity of the label as well as its components can be measured and evaluated by the haze value. The lower the haze value the more transparent the label.

The otherwise clear appearance of the label may be threatened in a case the label is being exposed to moisture. Water contained by the moisture is prone to affect the label appearance. The label may suffer from so-called water whitening.

Thus, there is a need for new clear-on-clear label solutions, especially relating to adhesive compositions showing improved water whitening resistance. Further, solutions that are food safe are desired for food labelling.

### SUMMARY

Aim of this specification is to provide a pressure sensitive adhesive composition that is able to maintain clarity also when exposed to moist or humid conditions or any other conditions that would endanger clarity of the adhesive. Further, the adhesive composition is safe to use in direct food contact application and thus does not pose any threat to consumer safety when used in food package labelling.

According to an embodiment, a pressure sensitive adhesive composition for clear-on-clear labels is provided. The PSA composition contains an aqueous polymer emulsion comprising an acrylic-based copolymer derived from components including (i) monomers comprising acrylate monomer(s) and vinyl aromatic compound(s), (ii) a reactive surfactant and (iii) a chain transfer agent. The PSA composition is resistant to water whitening and is in compliance with demands on food contact materials.

One embodiment provides a use of the PSA composition for an adhesive layer of a label laminate web or a label.

According to another embodiment, an adhesive label comprising a face layer of a filmic material and an adhesive layer adjoined to the face layer is provided. The adhesive layer comprises PSA composition containing an aqueous polymer emulsion comprising an acrylic-based copolymer derived from components including (i) monomers comprising acrylate monomer(s) and vinyl aromatic compound(s), (ii) a reactive surfactant and (iii) a chain transfer agent. The PSA composition is resistant to water whitening and is in compliance with demands on food contact materials.

According to yet another embodiment, a labelled item comprising an item and an adhesive label as described above is provided. The adhesive label is attached to a surface of the item via the adhesive layer of the adhesive label.

Finally, according to an embodiment, a label laminate web comprising a face stock of a filmic material, an adhesive layer and a release liner is provided. The face stock is adjoined to the release liner via the adhesive layer. The adhesive layer comprises PSA composition as described above.

Further embodiments are presented in the dependent claims.

### BRIEF DESCRIPTION OF THE DRAWINGS

FIG. 1 illustrates, by way of an example, a 3D view of an adhesive label according to an embodiment,

FIG. 2 illustrates, by way of an example, a cross sectional view of cut labels attached to a common release liner, and

FIG. 3 illustrates, by way of an example, an adhesive label attached to an item.

The figures are schematic. The figures are not in any particular scale.

### DETAILED DESCRIPTION

The solution is described in the following in more detail with reference to some embodiments, which shall not be regarded as limiting.

In this description and claims, the percentage values relating to an amount of a material are percentages by weight (wt. %) unless otherwise indicated. Term “comprising” may be used as an open term, but it also comprises the closed term “consisting of”. Unit of thickness expressed as microns corresponds to μm. Unit of temperature expressed as degrees C. corresponds to ° C. The following reference numbers and denotations are used in this application:
MRK1 graphics
Sx, Sy, Sz 3D coordinates
1 (adhesive) label
2 face layer
4 adhesive layer
6 release liner
8 label laminate web
10 backing material
12 release coating
100 item
101 labelled item

A label is a piece of material to be applied onto articles of different shapes and materials. An article may be a package. A label comprises at least a face material also referred to as a face stock or a face. A typical way to adhere the label onto an article is by use of adhesive. The label comprising an adhesive layer is referred to as an adhesive label. The adhesive may comprise pressure sensitive adhesive (PSA). A label comprising pressure sensitive adhesive may be referred to as a pressure sensitive adhesive label. Pressure sensitive adhesive labels may also be referred to as self-adhesive labels.

The labels comprising PSA can be adhered to most surfaces through an adhesive layer without the use of a secondary agent, such as a solvent, or heat to strengthen the bond. In that case the adhesive is pressure sensitive as such. Alternatively, the adhesive may be activatable in order to be pressure sensitive. The PSA forms a bond when pressure is applied onto the label at ambient temperature (e.g. between 15 and 35° C.) or for cold applications even under freezing temperatures below 0° C., adhering the label to the item to be labelled. Examples of pressure sensitive adhesives include water-based (water-borne) PSAs, solvent based PSAs and hot-melt PSAs. A label may further comprise other adhesive(s).

Term “face” refers to a top substrate of the label, also called as a face stock, a face material or in case of plastic, i.e. filmic, material a face film. The face may have a monolayer structure or a multilayer structure comprising at least two layers. In case of a plastic material the multilayer filmic structure may be co-extruded or it may comprise several layers laminated together. The face is the layer that is adhered to the surface of an article during labelling through an adhesive layer. The face comprises an adhesive side and a print side. A combination comprising a face and adhesive may be referred to as an adhesive label. The face may comprise e.g. print in order to provide information and/or visual effect. Printable face is suitable for printing by any known printing methods, such as with gravure, flexographic process, offset, screen or letter-press. The print may exist on a top surface, reverse side or both top and reverse side of the face. Further, the label may contain additional layers, for example top coatings or overlaminates to protect the top surface and/or print of the label against rubbing or other external stress. Coating or additional layers, such as a primer, may enable enhancing compatibility of adjacent layers or parts of the label, for example adhesion between the layers. A label comprising a face, a print layer and an adhesive may be referred to as a printed label.

Term “release liner” refers to a structure comprising a substrate and a release layer on a surface of the substrate contacting the adhesive in a label laminate. The substrate may also be called a backing material. The release liner may comprise a release agent. The release agent is a chemical having low surface tension. The release agent may be used in order to prevent other materials from bonding to it and to provide a release effect. Release liners of the label laminates may serve one or more useful functions: they may be used as a carrier sheet onto which the adhesive is coated; they may protect the adhesive layer during storage and transportation; they may provide a support for labels during die-cutting and printing, and ultimately they may provide the release substrate carrying the labels for dispensing onto the items to be labelled.

Term “label laminate”, also referred to as an adhesive label laminate refers to a product comprising a face, adhesive and a release liner. In the label laminate the face is laminated together with the release liner having the adhesive in between. The label laminate may be a continuous structure from which the individual labels may be die-cut. The release liner of the label laminate is typically removed prior to labelling i.e. attaching the label onto the surface of an item to be labelled.

Individual labels may be cut from the label laminate structure. After cutting, the labels may remain to be attached to a common release liner (the release liner remains uncut). Thus, a plurality of labels may remain to be attached to a common continuous release liner. This may be called a converted label web. Alternatively, the labels may be completely separate (i.e. also the release liner may be cut). A label, including a face and adhesive, may be separated from the release liner e.g. by pulling the release liner in the direction -Sz with respect to the label. Thus, a surface of the adhesive layer is exposed so that said surface can be attached to an article.

The label may also be a so-called linerless label. The linerless label comprises a mono- or multilayer face and an adhesive on the face. Alternatively the label may be a so-called shrink label, where the heat shrinkable polymeric face material(s) are seamed and rolled on or sleeved around labelled articles and shrunk around the items. Shrinkable labels may comprise additionally some pressure sensitive adhesive(s) or those may be produced completely without pressure sensitive adhesive, or even without seaming adhesive.

Term “web” refers to a continuous sheet of material. The web is generally processed by moving over rollers. Between processing stages, webs may be stored and transported as rolls.

Term “machine direction” refers to manufacturing direction of a web. Machine direction may also refer to a circumferential direction of a roll. Term “cross machine direction” or “cross direction” refers to a direction that is transversal to the machine direction.

Term “laminate web” refers to a structure comprising two or more continuous sheets of material attached together into a web format. Typically, the laminate web comprises a face material attached (laminated) onto a release liner via a pressure sensitive adhesive.

Labels may be used in wide variety of labelling applications and end-use areas, such as labelling of food, home and personal care products, industrial products, pharmaceutical and health care products, beverage and wine bottles, other consumables etc. Labels enable providing information, like product specification, on the labelled product(s). Information, e.g. print of a label, may comprise human-readable information, like image(s), logo(s), text, and/or machine-readable information, like bar code(s), QR (Quick Response) code(s). The surface of the labelled article may be for example plastics, glass, metal, or paper based. The labelled article may be for example a container, such as a bottle, jar, canister, can, tin or the like. The label may also be applied to semi-rigid or flexible packages used for e.g. packaging of food.

This specification aims to provide a pressure sensitive adhesive composition particularly suitable for so-called clear-on-clear labels in food package labelling. As already mentioned, clear-on-clear labels may be intended for providing a transparent package with a transparent label in order to provide a ‘no label’ look. Transparent ‘no label’ look appearance of the label is advantageous, for example, in applications where the objects beneath the label should be visible through the label. Clear-on-clear labels have a clear, i.e. transparent, film as their face. From the optical point of view, high transparency of the labels is preferred. Transparent (clear) labels are substantially transparent to visible light. In order to provide a clear label, also the adhesive of the label must be clear and be able to maintain the clarity under varying conditions. Within context of this specification, transparent item refers to an item having the property of transmitting light without appreciable scattering so that object(s) lying beyond are seen clearly.

Clarity of the label can be measured and evaluated by a haze value. Term haze refers to a property used to describe transparency of a label. Haze relates to scattering of light by the label that results in a cloudy appearance. Haze corresponds to the percentage of light transmitted through a label that is deflected from the direction of the incoming light. Haze may be measured according to standard ASTM D1003.

Aim of this specification is to provide a pressure sensitive adhesive composition that is able to maintain the clarity also when exposed to moist or humid conditions or any other conditions that would endanger clarity of the adhesive. Further, the adhesive composition is food safe and thus does not pose any threat to consumer safety when used in food package labelling.

The pressure sensitive adhesive composition disclosed herein is resistant to water whitening. Water whitening refers to loss of optical transparency when exposed to moisture or water, for example when being immersed in water.

Haze of the label comprising the pressure sensitive adhesive composition disclosed herein, after being immersed in room temperature water for 4 hours may be lower than 10%, for example 1-10%, preferably 1-8%, when measured according to standard ASTM D1003.

The pressure sensitive adhesive composition disclosed herein contains an aqueous, i.e. water-based or water-borne, polymer emulsion (also called aqueous polymer dispersion).

Water based polymer emulsion may have relatively low cost, ease of application and relatively low amounts of volatile organic compounds (VOC) contained therein. Further, water based polymer emulsion is suitable for use in food applications.

The aqueous polymer emulsion comprises an acrylic-based copolymer, i.e. acrylate copolymer. Copolymer refers to a polymer prepared from more than one monomers of different species. Amount of the acrylic-based copolymer may be from 45 to 60 wt. % of the emulsion weight.

The acrylic-based copolymer is derived from components including monomers comprising acrylate monomer(s) and vinyl aromatic compound(s), a reactive surfactant and a chain transfer agent. The acrylic-based copolymer may be derived from components consisting of acrylate monomer(s), vinyl aromatic compound(s), a reactive surfactant and a chain transfer agent.

Acrylate monomers in general are based on the structure of acrylic acid, which consists of a vinyl group and a carboxylic acid ester end or a nitrile.

Herein, the acrylate monomers utilized for producing the acrylic-based copolymer may comprise or consist of acid(s) and alkyl acrylate(s). The acrylate monomers utilized for producing the acrylic-based copolymer may comprise or consist of the following: acrylic acid, methyl acrylate, 2-ethyl hexyl acrylate. The acrylate monomers may further comprise methacrylic acid or β-carboxyethyl acrylate.

Following amounts of the acrylate monomers (by dry weight) may be present in the polymer emulsion:
from 0 to 5 wt. % acrylic acid
from 0 to 5 wt. % methacrylic acid
from 0 to 5 wt. % p-carboxyethyl acrylate
from 0 to 15 wt. % methyl acrylate
from 0 to 90 wt. % 2-ethyl hexyl acrylate

The amount of vinyl aromatic compound(s) (by dry weight) in the polymer emulsion may be from 0.1 to 10 wt. %. The vinyl aromatic compound(s) may comprise or consist of alpha-methyl styrene or styrene. In an example the polymer emulsion comprises alpha-methyl styrene in an amount of from 0.1 to 10 wt. % (by dry weight).

The aqueous polymer emulsion may comprise for example from 90 to 99 wt. % (by dry weight) monomers comprising acrylate monomer(s) and vinyl aromatic compound(s).

Reactive surfactant may also be called polymerizable and/or copolymerizable surfactant. Reactive surfactant comprises a reactive double bond via which it may be copolymerized with the monomers. After the polymerization process, there is no free surfactant left in the system. In general, role of a surfactant in the polymerization process is to form micelles and to emulsify monomers. For this, a reactive surfactant having a hydrophilic part and a hydrophobic part is preferred. The polymerization takes place in the micelles. The surfactant emulsifies and disperses the polymer particles. Conventional (non-reactive) surfactants may cause foaming in the polymerization process and on coated film. Conventional surfactants may also be responsible for weak water resistance of the polymer film.

Non-reactive surfactant is prone to migration to interfaces of the dispersion. This migration may then cause undesired whitening of the emulsion as well as peeling. Whitening or blushing is at least partially caused by adsorption of water by segregated hydrophilic islands in a dry adhesive layer, as well as subsequent expansion of said islands. After having reached a critical size, the expanded hydrophilic islands start to scatter visible light. Said light scattering is perceivable as gradual whitening. Increase in the size of the expanded hydrophilic islands may eventually lead to the disruption of the adhesive layer structure and loss of adhesion properties such as tackiness and eventually delamination of the label from the substrate surface.

Use of the reactive surfactant as disclosed herein has the effect that the surfactant is being uniformly dispersed and the formation of segregated hydrophilic islands may be avoided or at least diminished. Thus PSA composition containing acrylic-based copolymer derived from components including a reactive surfactant is substantially transparent and does not show unwanted peeling, i.e. delamination.

The acrylic adhesive composition including the reactive surfactant may have an effect on providing increased/improved initial tack for the label especially when the surface to be labelled is polar. Polar surfaces include glass, steel and PET. Use of reactive surfactant may also provide improved peel adhesion. High peel adhesion is important for label stability on the substrate, i.e. the labelled face. High peel adhesion prevents flagging, i.e. detachment at the label corners under humid conditions, transportation and during consumer usage of the labelled item. It is not very common to have both high initial tack and high peel adhesion (final adhesion) for an adhesive. It is quite often found that an adhesive showing a high initial tack does not show such good peel adhesion properties. However, the adhesive composition disclosed herein shows remarkably good values for both initial tack and peel adhesion.

The pressure sensitive adhesive composition disclosed herein may have initial tack on polar surface of at least 10 N/25 mm, preferably at least 12 N/25 mm when measured according to FTM 9. The pressure sensitive adhesive composition disclosed herein may have peel adhesion on polar surface of at least 12 N/25 mm when measured according to FTM 1 or FTM 2.

The polymer emulsion may comprise from 0.1 to 5 wt. % (by dry weight) reactive surfactant.

According to an embodiment, the reactive surfactant is an anionic surfactant. The reactive surfactant is an APE-free surfactant. APE-free surfactant is free of alkyl phenol ethoxylates (APEs) that have traditionally been widely used in emulsion polymerization due to their cost-effectiveness and performance. However, concerns about APE ecotoxicity have been raised thus leading to an effort to replace them with more environmentally friendly alternatives.

The anionic surfactant may comprise the following structure represented by Formula (I):

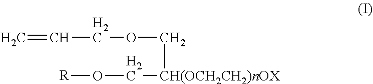

where R is alkyl group; X is SO₃NH₄; and n is from 3 to 50.

Content of ethylene oxide (—(OCH₂CH₂)ₙ—) units in the anionic surfactant having the Formula (I) may be from 10 to 30 mol. Greater number of ethylene oxide units may be responsible for inducing a slightly higher viscosity for the emulsion formed. It may also have an effect on the adhesion properties, such as tack and peel adhesion. Tack and peel adhesion may be increased by using a surfactant of Formula (I) having a higher number of ethylene oxide units when compared to one with fewer ethylene oxide units.

Within context of this specification, the reactive surfactant may contain components which are capable of acting as an internal crosslinker during the polymerization process. Said components may have polymerizable double bonds. Surfactant is capable of reacting with acrylic monomers. Crosslinkers typically affect the adhesive performance in a negative way and the performance of the resulting adhesive composition does not meet the requirements for filmic label applications. However, negative effects caused by the crosslinking may be compensated by using a chain transfer agent. The chain transfer agent may be responsible for controlling average polymer chain length of the acrylic-based copolymer. According to an embodiment, the chain transfer agent is n-dodecyl mercaptane (n-DDM) or t-dodecyl mercaptane (t-DDM).

The polymer emulsion may comprise from 0.005 to 0.5 wt. % (by dry weight) chain transfer agent.

Besides the acrylic-based copolymer the aqueous polymer emulsion may comprise for example a buffer, such as tetrasodium pyrophosphate.

The aqueous polymer emulsion preferably comprises water alone as the aqueous medium. Alternatively, the aqueous medium may consist of a mixture of water and water-miscible liquid, such as methanol. However, the overwhelming majority of the aqueous medium is water.

For providing the pressure sensitive adhesive composition the aqueous polymer emulsion described above may be formulated by adding at least one of a neutralizing agent, a wetting agent, a biocide, a defoamer, a rheology modifier.

The pressure sensitive adhesive composition, i.e. the aqueous polymer emulsion described above after being formulated, may have a pH of about 6-7, for example about 6.5. The Brookfield viscosity may be between 400 and 1200 cP, when measured at 100 rpm using spindle #3. The pressure sensitive adhesive may have a solids content of from 40 to 60 wt. %. Particle size (average) of the pressure sensitive adhesive may be from 80 to 350 nm, preferably from 100 to 200 nm. Smaller particle size provides better water whitening resistance and higher viscosity. Amount of grit, i.e. a material of filterable, solid particles having a diameter of at least 200 μm may be less than 300 ppm.

The pressure sensitive adhesive composition comprising the aqueous polymer emulsion as disclosed herein possesses excellent adhesion properties, including shear resistance, peel adhesion and tack.

Shear resistance refers to a measure of an adhesive's vertical holding power, i.e. internal cohesive strength of the adhesive. It is generally measured by arranging a specific surface area of adhesive to a substrate, attaching a known weight to the adhesive and the substrate, and then measuring the amount of time the adhesive would hold the weight. Shear resistance may be measured according to FINAT Test Method No. 8 (FTM 8). A low-shear adhesive (soft) has more of a tendency to flow resulting in higher initial tack. However, low-shear adhesive may have a higher chance of the adhesive being split apart under stress. A high-shear adhesive (firm) is less likely to split under stress due to its higher internal cohesive strength. The high-shear adhesive may have reduced tendency to flow and thus may have lower initial tack.

The pressure sensitive adhesive composition disclosed herein is a high-shear adhesive. According to an embodiment, the shear resistance of the pressure sensitive adhesive composition disclosed herein is 6000+ min. The reactive surfactant containing components being capable of acting as an internal crosslinker during the polymerization process may be contributing for the high shear resistance of the adhesive disclosed herein.

Peel adhesion refers to a measure of the adhesive's ability to wet out a surface of a substrate and subsequently adhere to the substrate. Peel adhesion thus may quantify the permanence of the adhesion or peel ability of the adhesive. Peel adhesion is defined as the force required to remove adhesive coated material from a standard test plate after a certain dwell time at an angle of 90 degrees or 180 degrees and specified speed. Peel adhesion thus refers to final adhesion. Peel adhesion may be measured according to FINAT Test Method No. 1 or 2 (FTM 1, FTM 2).

Tack refers to an adhesive's holding power (adhesion) upon contact with a substrate. An adhesive with high initial tack will grab the substrate quickly. An adhesive with low initial tack will exhibit a low level of adhesion when applied. Tack can be measured by loop tack measurement according to FINAT Test Method No. 9 (FTM 9). The loop tack value of the adhesive is expressed as the force required to separate, at specified speed, a loop of material brought into contact with a specified area of a standard surface.

The pressure sensitive adhesive composition disclosed herein may exhibit the following peel adhesion and tack values:
the peel adhesion on glass from 15 to 20 N/25 mm
the tack on glass from 15 to 20 N/25 mm
the peel adhesion on PET from 15 to 20 N/25 mm
the tack on PET from 13 to 20 N/25 mm
the peel adhesion on HDPE from 10 to 15 N/25 mm
the tack on HDPE from 5 to 10 N/25 mm.

For comparison, two reference samples were prepared and their adhesion properties studied. Reference sample 1 contained a combination of conventional, non-reactive surfactants instead of the reactive surfactant in the polymerization process. Reference sample 2, for one, differed from the composition disclosed herein only in that it did not contain the chain transfer agent.

Reference sample 1 showed lower peel adhesion and tack values on glass (peel 8.5 N/25 mm, tack 3.5 N/25 mm) and on HDPE, i.e. high-density polyethylene, (peel 4.5 N/25 mm, tack 4 N/25 mm) when compared to the values obtained for the PSA according to this disclosure. Further, shear resistance value of reference sample 1 was 29 min.

Reference sample 2 showed comparable shear resistance (6000+ min) when compared to the PSA according to this disclosure. However, also reference sample 2 showed lower peel adhesion and tack values on glass (peel 7.5 N/inch, tack 8.5 N/25 mm), on PET (peel 8 N/25 mm, tack 7.5 N/25 mm) and on HDPE (peel 2.5 N/25 mm, tack 3 N/25 mm).

Water whitening, i.e. blushing, of the adhesive under exposure to moisture or water was investigated for the adhesive composition according to this disclosure as well as the reference samples 1 and 2 as described above. The samples were prepared by coating liquid emulsions on a silicon release liner and drying at 100 degrees C. for 5 minutes. The dried adhesive samples were laminated with 2 mil clear PET (polyethylene terephthalate) film and then cut into 1 inch by 3 inch strips. The release liner of the strip was removed and PET face having the dry adhesive thereon was immersed in room temperature water for 4 hours. After 4 hours opacity/transparency of the laminate was rated visually on a scale from 0 to 5, wherein 0 means no whitening (blushing) observed and 5 corresponds to complete, 100% whitening, i.e. the adhesive turning matt white.

The pressure sensitive adhesive composition comprising the aqueous polymer emulsion as disclosed herein showed no whitening/blushing after the water whitening test as described above, and thus obtained the water whitening value 0. Reference sample 1 showed unacceptably high level of blushing after 4 hours (value being 4). Reference sample 2 managed better in the water whitening test. However, it showed somewhat higher water whitening than the PSA according to this disclosure, obtaining a water whitening value of 0.5.

From the above studies it may be concluded that using a combination of conventional, non-reactive surfactants instead of reactive surfactant according to this disclosure (reference sample 1) leads to an adhesive showing poor water whitening resistance as well as very low adhesion and shear performance.

This demonstrates the positive effect of the reactive surfactant to the adhesive performance and the water whitening resistance, and thus emphasizes the usability of the disclosed adhesive composition in clear-on-clear labelling applications, wherein besides water whitening resistance also excellent adhesive performance are prerequisites.

Results achieved for reference sample 2 not including a chain transfer agent illustrates the significance of the presence of the chain transfer agent for obtaining desired adhesion performance in particular for filmic applications. Based on the studies the chain transfer agent also has a positive effect on the water whitening resistance.

For edible consumables, the materials of the package should be food safe. Thus, it is preferable that also the materials of the label comprised by the package are food safe. Food safe materials may also be referred to as food grade materials, food certified materials or food approved materials. Food safe materials may refer to materials that have been given by an accredited laboratory an approval for direct contact with dry and moist non-fatty foods. Food safe materials may refer to materials that are in compliance with at least one of the following EC regulations: EC 1935/2004, EC 2023/2006, EU 15 10/2011 or with the demands of the Code of Federal Regulations, Food and Drug Administration (FDA), 21 CFR Ch. I (April, 2012 edition) § 175.105 and § 175.125.

The pressure sensitive adhesive composition disclosed herein is food safe. The pressure sensitive adhesive composition disclosed herein is in compliance with the demands on food contact materials.

Legal requirements in various nations for a material to be food safe may vary, but generally it is assured that a food safe container is free of any toxic contaminants which could be contacted from the manufacturing process and that the container material shall not potentially become a source of toxic contamination through usage (degeneration). The latter is assured by estimating and regulating the migration limits of the material.

Possible migrating components may originate from the adhesive and/or in the case of label materials, from the face material. For the adhesive, those compounds include for example residual monomers, residual surfactant, left-over initiator from the polymerization process as well as impurities contained by the raw materials, such as impurities that are inactive in the polymerization process.

The pressure sensitive adhesive composition disclosed herein preferably meets the applicable limit values defined in the Commission Regulation (EU) No 10/2011 of 14 Jan. 2011 on plastic materials and articles intended to come into contact with food, Official Journal of the European Union L12/1 of 15 Jan. 2011, last amendment by Commission Regulation (EU) 2020/1245 of 2 Sep. 2020, Official Journal of the European Union L 288/1 of 3 Sep. 2020.

According to an embodiment, the pressure sensitive adhesive composition disclosed herein exhibits overall migration of below 10 mg/dm² when determined according to EN 1186 and EN 13130 standards using ethanol 10% (v/v) and testing conditions of 24 hours at 40 degrees C. Due to this, the pressure sensitive adhesive composition disclosed herein may be used safely for the reverse coating of labels for the labelling of food stored at room temperature. The adhesive composition may stand in direct contact with dry, moist, non-fatty food.

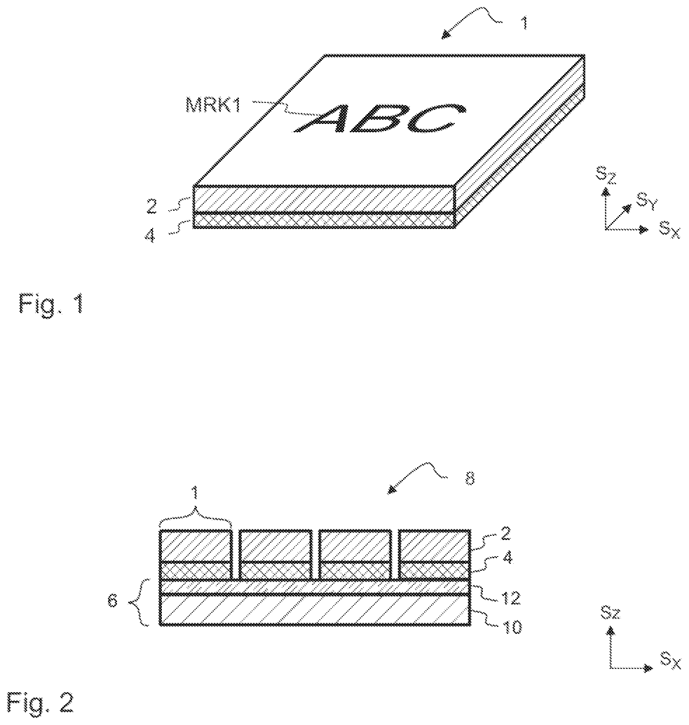

The pressure sensitive adhesive composition presented herein may be used for producing adhesive labels. Referring to FIG. 1 an adhesive label 1 comprises a face layer 2 of a filmic material and an adhesive layer 4 adjoined to the face. The adhesive layer 4 comprises PSA composition according to this disclosure. Suitable filmic materials include, for example, films of polyolefins (e.g. polyethylene, polypropylene), polyolefin copolymers, films of polyesters (e.g. polyethylene terephthalate) or polyacetate. Preferably the face film is a polypropylene or a polyethylene terephthalate film. The face layer may be for example a biaxially oriented polypropylene (BOPP) film. The adhesive label may include graphical patterns, i.e. graphics, MRK1 on its face layer 2. A top surface of the face layer 2 may be printed. The printing may be subsequently top coated in order to protect the printing. Alternatively or in addition, the reverse side of the face layer adjacent to the adhesive layer 4 may be printed.

A label laminate web 8 may be provided for producing the adhesive labels 1. The label laminate web 8 comprises a continuous face layer 2 , i.e. a face stock, of a filmic material being adjoined to a release liner 6 via an adhesive layer 4 comprising the PSA composition according to this disclosure. The release liner 6 comprises a backing material 10 and a release coating 12. The individual adhesive labels 1 can be cut from the label laminate web. Referring to FIG. 2, a label laminate web 8 comprises four cut labels 1 attached to a common release liner 6. During labelling the release liner 6 is removed and the label 1 is attached onto a surface to be labelled through the adhesive layer 4.

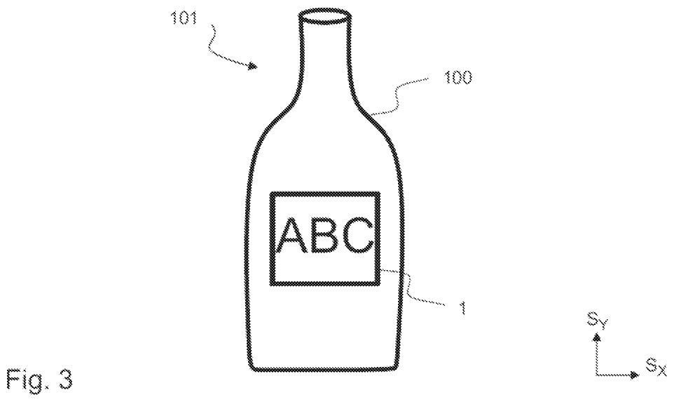

Referring to FIG. 3 an adhesive label 1 can be affixed to a surface of an item 100 through an adhesive layer 4 so as to form a labelled item 101. Adhesive layer provides adhesion i.e. adheres or bonds the label to the surface of the item. The adhesive layer 4 may be a continuous coating covering 100% of the face layer surface. Alternatively, it may be applied discontinuously as spots or strips covering less than 100% of the face layer surface. The item 100 may be any item suitable for labelling. Particularly, the item 100 may be transparent or clear item. According to an embodiment, the item 100 is a beverage bottle. The beverage bottle may be for example a glass bottle or a polyethylene terephthalate bottle.

1. A pressure sensitive adhesive composition for clear-on-clear labels containing an aqueous polymer emulsion comprising
an acrylic-based copolymer derived from components including
(i) monomers comprising acrylate monomer(s) and vinyl aromatic compound(s),
(ii) a reactive surfactant and
(iii) a chain transfer agent,
wherein
the pressure sensitive adhesive composition is resistant to water whitening and is in compliance with demands on food contact materials, and wherein the acrylate monomers comprise or consist of the following: acrylic acid, methyl acrylate, 2-ethyl hexyl acrylate, and the vinyl aromatic compound comprises or consists of alpha-methyl styrene.

2. (canceled)

3. The pressure sensitive adhesive composition according to claim wherein the acrylate monomer(s) further comprise methacrylic acid or P-carboxyethyl acrylate.

4. (canceled)

5. The pressure sensitive adhesive composition according to 1, wherein the reactive surfactant is an anionic surfactant.

6. The pressure sensitive adhesive composition according to claim 1, wherein the reactive surfactant contains components which are capable of acting as an internal crosslinker.

7. The pressure sensitive adhesive composition according to claim 1, wherein the reactive surfactant has the following structure represented by Formula (I): 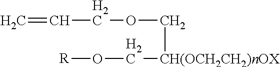
where R is alkyl group; X is SO₃NH₄; and n is from 3 to 50.

8. The pressure sensitive adhesive composition according to claim 1, wherein the chain transfer agent is n-dodecyl mercaptane or t-dodecyl mercaptane.

9. The pressure sensitive adhesive composition according to claim 1, having an average particle size of from 80 to 350 nm.

10. The pressure sensitive adhesive composition according to claim 1, having an initial tack on a polar surface of at least 10 N/25 mm when measured according to FTM 9.

11. The pressure sensitive adhesive composition according to claim 1, having a peel adhesion on a polar surface of at least 12 N/25 mm when measured according to FTM 1 or FTM 2.

12. The pressure sensitive adhesive composition according to claim 1, exhibiting an overall migration of below 10 mg/dm² when determined according to EN 1186 and EN 13130 standards using ethanol 10% (v/v) and testing conditions of 24 hours at 40 degrees C.

13. Use of a pressure sensitive adhesive composition according to claim 1, for an adhesive layer (4) of a label laminate web (8) or a label (1).

14. An adhesive label (1) comprising a face layer (2) of a filmic material and an adhesive layer (4) adjoined to the face layer, wherein the adhesive layer (4) comprises pressure sensitive adhesive composition according to claim 1.

15. The adhesive label (1) according to claim 14, showing a haze value of lower than 10% after being immersed in room temperature water for 4 hours, when measured according to standard ASTM D1003.

16. A labelled item (101) comprising an item (100) and an adhesive label (1) according to claim wherein the adhesive label (1) is attached to a surface of the item via the adhesive layer (4) of the adhesive label.

17. The labelled item (101) according to claim 16, wherein the item (100) is a beverage bottle.

18. A label laminate web (8) comprising a face stock (2) of a filmic material, an adhesive layer (4) and a release liner (6), the face stock (2) being adjoined to the release liner (6) via the adhesive layer (4), wherein the adhesive layer (4) comprises pressure sensitive adhesive composition according to claim 1.
